(19) United States
(12) Patent Application Publication
(10) Pub. No.: US 2021/0356802 A1
(43) Pub. Date: Nov. 18, 2021

(54) DISPLAY PANEL, AND METHOD OF MANUFACTURING SAME

(71) Applicant: TCL CHINA STAR OPTOELECTRONICS TECHNOLOGY CO., LTD., Shenzhen (CN)

(72) Inventor: Huihua Liao, Shenzhen, Guangdong (CN)

(21) Appl. No.: 16/617,172

(22) PCT Filed: Nov. 15, 2019
(86) PCT No.: PCT/CN2019/118961

§ 371 Date: Nov. 26, 2019

(30) Foreign Application Priority Data
Aug. 12, 2019 (CN) 201910738698.X

(51) Int. Cl. G02F 1/1333; G09F 9/35

(52) U.S. Cl. CPC G02F 1/133374; G09F 9/35; G02F 1/133308; G02F 1/133388

(57) ABSTRACT

A display panel, and a method of manufacturing the same are provided. The display panel includes a display region and a non-display region. The display region is disposed at a center of the display panel. The non-display region is disposed around the display region. One side of the non-display region is provided with an identification code pattern. The identification code pattern is provided by using an exposure machine and then printed by a coding machine. The identification code pattern is a regular graphic.

### FIELD OF INVENTION

The present disclosure relates to display technologies, and more particularly, to a display panel, and a method of manufacturing the same.

### BACKGROUND OF INVENTION

In a process of manufacturing a display panel, in order to distinguish an information of a glass plate (a liquid crystal display mother board), it is convenient to track the glass by marking each glass plate with a glass identification (ID) (liquid crystal display mother board identification code). In actual, the glass plate will cut into a number of small sub-display panels. In order to distinguish each sub-display panel, it is also marking each of each sub-display panel with a panel ID (sub-display panel identification code) generally.

However, in the manufacturing process of the display panel, due to a number of identification codes and an entire long production cycle of a code printer, a production capacity of a production line is affected. A size and a shape of the liquid crystal display mother board identification code and a size and a shape of the sub display panel identification code are different. Therefore, there are different identification codes needs to be print in the production line. In addition, due to an accuracy problem of the code printer itself, the liquid crystal display mother board identification code and the sub-display panel identification code occupy a large area of a non-display region of the display panel, which affects a size of a frame of the display panel.

Therefore, in an existing display panel technology, there are a large number of liquid crystal display mother board identification codes and sub display panel identification codes, a long production cycle, and a large occupying area of the non-display region of the display panel in the production process of the display panel. Therefore, there is a need to solve the above issues.

### SUMMARY OF INVENTION

In view of the above, the present disclosure provides a display panel, and a method of manufacturing the same to resolve technical issues that there are a large number of liquid crystal display mother board identification codes and sub display panel identification codes, a long production cycle, and a large occupying area of the non-display region of the display panel in the production process of the display panel.

In order to achieve above-mentioned object of the present disclosure, one embodiment of the disclosure provides a display panel including a display region and a non-display region.

The display region is disposed at a center of the display panel, and the display region is rectangle.

The non-display region is disposed around the display region, and one side of the non-display region is provided with an identification code pattern.

The identification code pattern is provided by using an exposure machine and then printed by a coding machine, and the identification code pattern is a regular graphic.

In one embodiment of the disclosure, the display region is rectangle.

In one embodiment of the disclosure, an area of the display region is greater than an area of the non-display region.

In one embodiment of the disclosure, the identification code pattern includes at least an identification frame.

In one embodiment of the disclosure, each side of the identification frame has a predetermined exposing width.

In one embodiment of the disclosure, the predetermined exposing width of each of the side of the identification frame is 3 μm.

In one embodiment of the disclosure, each of the identification frame has a predetermined exposing length and width.

In one embodiment of the disclosure, the predetermined exposing length and width of each of the identification frame both are 45 μm.

In one embodiment of the disclosure, each of the identification code pattern has a predetermined exposing length and width.

In one embodiment of the disclosure, the predetermined exposing length of each of the identification code pattern is 429 μm, and the predetermined exposing width of each of the identification code pattern is 45 μm.

Furthermore, another embodiment of the disclosure provides a display panel including a display region and a non-display region.

The display region is disposed at a center of the display panel, and the display region is rectangle.

The non-display region is disposed around the display region, and one side of the non-display region is provided with an identification code pattern.

The identification code pattern is provided by using an exposure machine and then printed by a coding machine, and the identification code pattern is a regular graphic.

In one embodiment of the disclosure, the display region is rectangle.

In one embodiment of the disclosure, an area of the display region is greater than an area of the non-display region.

In one embodiment of the disclosure, the identification code pattern includes at least an identification frame.

In one embodiment of the disclosure, each side of the identification frame has a predetermined exposing width.

In one embodiment of the disclosure, the predetermined exposing width of each of the side of the identification frame is 3 μm.

In one embodiment of the disclosure, each of the identification frame has a predetermined exposing length and width.

In one embodiment of the disclosure, the predetermined exposing length and width of each of the identification frame both are 45 μm.

In one embodiment of the disclosure, the identification code pattern includes at least one of a number, a letter, a symbol, and a two-dimensional code.

Furthermore, another embodiment of the disclosure provides a method of manufacturing a display panel, including steps of:

step S10: providing a substrate, a mask, an exposure machine, and a coding machine;

step S20: forming an identification frame at one side of a non-display region of the substrate by the exposure machine in cooperation with the mask;

step S30: continuing forming another identification frame to provide a frame of an identification code pattern;

step S40: printing by the coding machine within the substrate provided with the identification code pattern thereon; and

step S50: developing, and etching the substrate after step S40 to form the identification code pattern includes at least one of a number, a letter, a symbol, and a two-dimensional code.

In comparison with prior art, the display panel of the disclosure provides the identification code pattern in the non-display region of the display panel. The identification code pattern is a regular graphic and provided by using an exposure machine and then printed by a coding machine. There is no need to add new machine or to change a production process. A duration for code printing is reduced, and a production cycle is reduced.

The display panel of the disclosure provides the identification code pattern by using an exposure machine and then printed by a coding machine. A exposure precision of the exposure machine can reach 3 which greatly reduces a size of the identification code pattern, and is advantageous for achieving a narrow border.

### BRIEF DESCRIPTION OF DRAWINGS

In order to more clearly illustrate embodiments or technical solutions in prior art, drawings to be used in description of the embodiments or the prior art will be briefly described below. Obviously, the drawings in the following description are merely some embodiments of the invention. Considering the drawings, other drawings may be obtained by those of ordinary skill in the art without creative effort.

FIG. 1 is a schematic view of a structure of a display panel according to an embodiment of the present disclosure.

FIG. 2 is a schematic view of an identification code pattern structure of the display panel according to an embodiment of the present disclosure.

FIG. 3 is a schematic view of an identification frame of the identification code pattern according to an embodiment of the present disclosure.

FIG. 4 is a schematic flowchart of a method of manufacturing a display panel according to an embodiment of the present disclosure.

### DETAILED DESCRIPTION OF PREFERRED EMBODIMENTS

The following description of the embodiments is provided by reference to the drawings and illustrates the specific embodiments of the present disclosure. Directional terms mentioned in the present disclosure, such as “up,” “down,” “top,” “bottom,” “forward,” “backward,” “left,” “right,” “inside,” “outside,” “side,” “peripheral,” “central,” “horizontal,” “peripheral,” “vertical,” “longitudinal,” “axial,” “radial,” “uppermost” or “lowermost,” etc., are merely indicated the direction of the drawings. Therefore, the directional terms are used for illustrating and understanding of the application rather than limiting thereof.

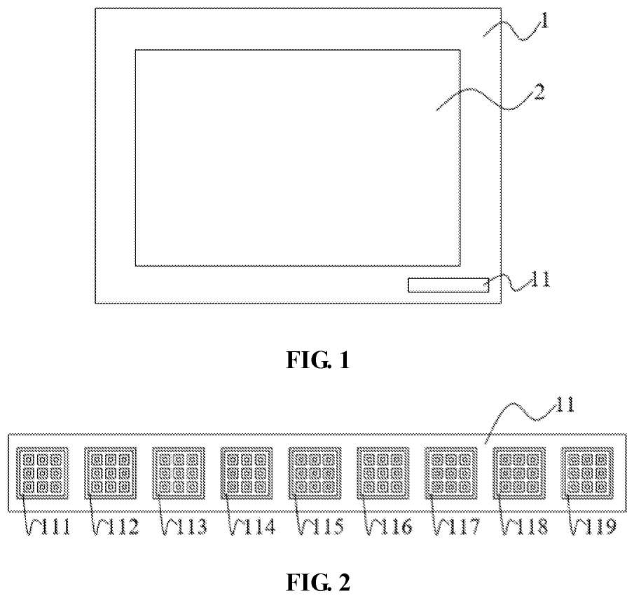

Referring to FIG. 1, FIG. 1 is a schematic view of a structure of a display panel according to an embodiment of the present disclosure. One embodiment of the disclosure provides a display panel including a non-display region 1 and a display region 2. The display region is disposed at a center of the display panel. The non-display region is disposed around the display region. The non-display region 1 is provided with an identification code pattern 11. The identification code pattern 11 is disposed on one side of the non-display region 1. The identification code pattern is provided by using an exposure machine and then printed by a coding machine, and the identification code pattern is a regular graphic. The identification code pattern is not limited to the rectangle provided by the drawings of the embodiments of the present application, and may be trapezoidal, square, circular or elliptical. An area of the display region is greater than an area of the non-display region.

Referring to FIG. 2, FIG. 2 is a schematic view of an identification code pattern structure of the display panel according to an embodiment of the present disclosure. The identification code pattern 11 includes a first identification frame 111, a second identification frame 112, a third identification frame 113, a fourth identification frame 114, a fifth identification frame 115, a sixth identification frame 116, a seventh identification frame 117, an eighth identification frame 118, and a ninth identification frame 119. The identification code pattern includes at least one identification frame, and is not limited to the number of the identification frames as shown in FIG. 2 of the embodiments of the present application

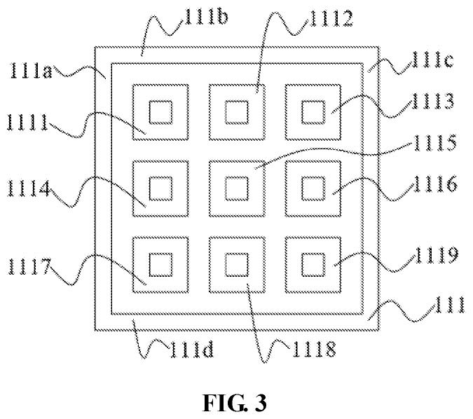

Referring to FIG. 3, FIG. 3 is a schematic view of a structure of an identification frame of the identification code pattern according to an embodiment of the present disclosure. The identification frame 111 includes a first dot 1111, a second dot 1112, a third dot 1113, a fourth dot 1114, a fifth dot 1115, a sixth dot 1116, a seventh dot 1117, an eighth dot 1118, and a ninth dot 1119. The identification frame 111 includes four sides, a first side 111a, a second side 111b, a third side 111c, and a fourth side 111d.

The first side 111a, the second side 111b, the third side 111c, and the fourth side 111d form the identification frame 111 to surround the first dot 1111, the second dot 1112, the third dot 1113, the fourth dot 1114, the fifth dot 1115, the sixth dot 1116, the seventh dot 1117, the eighth dot 1118, and the ninth dot 1119. The first side 111a, the second side 111b, the third side 111c, and the fourth side 111d are produced by the exposure machine in cooperation with the mask. Widths of sides of the first side 111a, the second side 111b, the third side 111c, the fourth side 111d, and every dot have a predetermined precision. Each side of the identification frame has a predetermined exposing width. The predetermined exposing width of each side of the identification frame 111 is 3 μm. In one embodiment of the disclosure, each of the identification frame 111 has a predetermined exposing length and width. The predetermined exposing length and width of each of the identification frame both are 45 μm. In one embodiment of the disclosure, each of the identification code pattern has a predetermined exposing length and width. The predetermined exposing length of each of the identification code pattern is 429 μm, and the predetermined exposing width of each of the identification code pattern is 45 μm.

In one embodiment of the disclosure, the identification code pattern 11 includes at least one of a number, a letter, a symbol, and a two-dimensional code. In one embodiment of the disclosure, the identification code pattern 11 is made of a material comprises metal or poly-silicon.

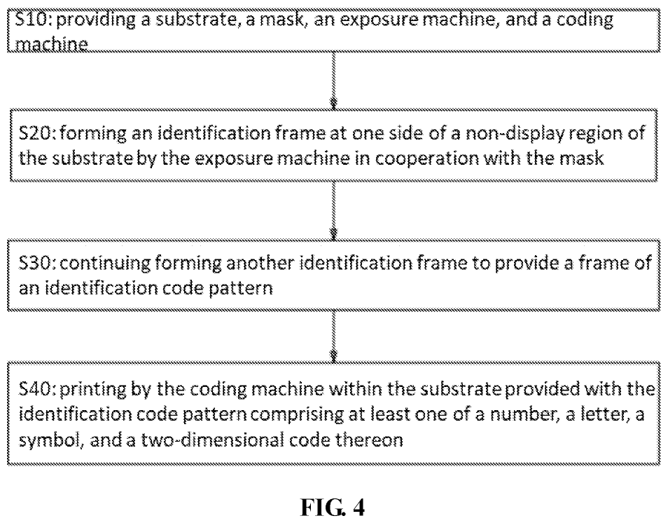

Furthermore, referring to FIG. 4, another embodiment of the disclosure provides a method of manufacturing a display panel, including steps of: step S10: providing a substrate, a mask, an exposure machine, and a coding machine; step S20: forming an identification frame at one side of a non-display region of the substrate by the exposure machine in cooperation with the mask; step S30: continuing forming another identification frame to provide a frame of an identification code pattern; step S40: printing by the coding machine within the substrate provided with the identification code pattern thereon; and step S50: developing, and etching the substrate after step S40 to form the identification code pattern includes at least one of a number, a letter, a symbol, and a two-dimensional code.

The step S20 further includes: step S201: forming a first side 111a, a second side 111b, s third side 111c, and a fourth side 111d of the identification frame in the non-display region of the substrate with a mask; step S202: forming a first dot 1111, a second dot 1112, a third dot 1113, a fourth dot 1114, a fifth dot 1115, a sixth dot 1116, a seventh dot 1117, an eighth dot 1118, and a ninth dot 1119 within the identification frame 111 with a mask.

A surface of the substrate in the step S10 is coating with a positive photoresist or negative photoresist. The identification code pattern 11, a gate, and a common electrode are disposed at a same layer in the aforementioned process.

In comparison with prior art, the display panel of the disclosure provides the identification code pattern in the non-display region of the display panel. The identification code pattern is a regular graphic and provided by using an exposure machine and then printed by a coding machine. There is no need to add new machine or to change a production process. A duration for code printing is reduced, and a production cycle is reduced. The display panel of the disclosure provides the identification code pattern by using an exposure machine and then printed by a coding machine. A exposure precision of the exposure machine can reach 3 which greatly reduces a size of the identification code pattern, and is advantageous for achieving a narrow border.

The present disclosure has been described by the above embodiments, but the embodiments are merely examples for implementing the present disclosure. It must be noted that the embodiments do not limit the scope of the invention. In contrast, modifications and equivalent arrangements are intended to be included within the scope of the invention.

What is claimed is:

1. A display panel, comprising: a display region and a non-display region;
wherein the display region is disposed at a center of the display panel, and the display region is rectangle;
wherein the non-display region is disposed around the display region, and one side of the non-display region is provided with an identification code pattern; and
wherein the identification code pattern is provided by using an exposure machine and then printed by a coding machine, and the identification code pattern is a regular graphic.

2. The display panel according to claim 1, wherein an area of the display region is greater than an area of the non-display region.

3. The display panel according to claim 1, wherein the identification code pattern comprises at least an identification frame.

4. The display panel according to claim 3, wherein each side of the identification frame has a predetermined exposing width.

5. The display panel according to claim 4, wherein the predetermined exposing width of each of the side of the identification frame is 3 μm.

6. The display panel according to claim 5, wherein each of the identification frame has a predetermined exposing length and width.

7. The display panel according to claim 6, wherein the predetermined exposing length and width of each of the identification frame both are 45 μm.

8. The display panel according to claim 1, wherein each of the identification code pattern has a predetermined exposing length and width.

9. The display panel according to claim 8, wherein the predetermined exposing length of each of the identification code pattern is 429 μm, and the predetermined exposing width of each of the identification code pattern is 45 μm.

10. The display panel according to claim 1, wherein the identification code pattern comprises at least one of a number, a letter, a symbol, and a two-dimensional code.

11. The display panel according to claim 1, wherein the identification code pattern is made of a material comprises metal or poly-silicon.

12. A display panel, comprising: a display region and a non-display region;
wherein the display region is disposed at a center of the display panel;
wherein the non-display region is disposed around the display region, and one side of the non-display region is provided with an identification code pattern; and
wherein the identification code pattern is provided by using an exposure machine and then printed by a coding machine, and the identification code pattern is a regular graphic.

13. The display panel according to claim 12, wherein an area of the display region is greater than an area of the non-display region.

14. The display panel according to claim 13, wherein the identification code pattern comprises at least an identification frame.

15. The display panel according to claim 14, wherein each side of the identification frame has a predetermined exposing width.

16. The display panel according to claim 15, wherein the predetermined exposing width of each of the side of the identification frame is 3 μm.

17. The display panel according to claim 16, wherein each of the identification frame has a predetermined exposing length and width.

18. The display panel according to claim 17, wherein the predetermined exposing length and width of each of the identification frame both are 45 μm.

19. A method of manufacturing a display panel, comprising steps of:
step S10: providing a substrate, a mask, an exposure machine, and a coding machine;
step S20: forming an identification frame at one side of a non-display region of the substrate by the exposure machine in cooperation with the mask;
step S30: continuing forming another identification frame to provide a frame of an identification code pattern;
step S40: printing by the coding machine within the substrate provided with the identification code pattern thereon; and
step S50: developing, and etching the substrate after step S40 to form the identification code pattern comprises at least one of a number, a letter, a symbol, and a two-dimensional code.
